(19) United States
(12) Patent Application Publication
(10) Pub. No.: US 2005/0134903 A1
(43) Pub. Date: Jun. 23, 2005

(54) Communication device and data conversion device

(75) Inventors: Yoshifumi Tanimoto, Osaka (JP); Shinji Kawasaki, Joyo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/973,451

(22) Filed: Oct. 27, 2004

(30) Foreign Application Priority Data
Dec. 2, 2003 (JP) 2003-402686
Dec. 12, 2003 (JP) 2003-414429
Jan. 8, 2004 (JP) 2004-002654

(51) Int. Cl. G06F 13/00; G06F 15/00; H04N 1/21; H04N 1/00

(52) U.S. Cl. 358/1.15; 358/403; 358/1.16; 358/444

(57) ABSTRACT

A communication device which reduces labor of a user required for an operation for specifying data without losing convenience of the data, and a data conversion device which converts the data into data which can be used in such a communication device. When creating a transmission file by a terminal device, an identifier is added to the file by a driver and the file is stored in any location within a retrieval range. At the communication device, the user inputs an identifier from an input unit. With the identifier as a retrieval key, a file on a data exchange network is retrieved and the acquired file is transmitted as a transmission file from a communication unit. In this case, the identifier added to the file is deleted and then the file is transmitted. When a plurality of files are retrieved, the files are selected and designated by the user and the selected file is transmitted.

### BACKGROUND OF THE INVENTION

1. Field of the Invention

The present invention relates to a communication device such as a Multi Function Peripheral (MFP) which transmits a content of a file stored in advance on a network or in the communication device.

2. Description of the Related Art

A conventional facsimile machine scans an image by a scanner and transmits the scanned image as it is. However, a recent facsimile machine stores a scanned image once and transmits the image later. Alternatively, a recent facsimile machine receives a transmission image from a remote device via a network and transmits the image. The transmission is not limited to facsimile communication and an electronic mail transmission is also carried out. Transmitted information is not limited to image data and various data on the network can be transmitted.

A method for storing facsimile transmission data in a prescribed information box of a facsimile machine is adopted in many cases. However, a user is required to carry out an operation in advance for storing transmission data in a prescribed information box. The prescribed information box can be used only for the transmission. Therefore, there is a drawback that the conventional method lacks convenience.

When considering convenience of data, the transmission data is preferable to be located at any location on the network. However, when transmitting the data located at any location, in general, the location of the data is required to be designated. For designating the location of the data, as user input information, it is necessary to designate information such as which device on the network, which folder and which file the data is located. When designating the location of the data, the user is required to input an extremely large number of character strings. Therefore, the user is required to present a large amount of labor and errors in the input character strings are generated frequently.

For reducing the labor of the user in the input operation, there is a technology in which the user input information and an identifier or the like are registered by being associated to one another and the user input information is specified by inputting the identifier or the like. However, also in this case, since the user input information is stored in a specific server or the like, it is difficult to use the user input information in processes other than the transmission to a specific transmission destination. The user input information is originally not a piece of information to be used widely. Therefore, the user input information is managed appropriately in a specific server or the like. Thus, for general users, the above-described conventional technology does not improve convenience nor reduce the labor of the input operation.

Accompanying an increase in a number of functions of a recent facsimile machine, not only is an image scanned by a scanner transmitted by facsimile and an image received by facsimile printed out by a printer, the Internet communication using L-mode can also be used. A recent facsimile machine is connected to a data exchange network such as a Local Area Network (LAN). The recent facsimile machine includes a function for receiving a transmission image via the data exchange network and forwarding the received image.

Furthermore, a recent facsimile machine can directly handle a file on the data exchange network. For example, a recent facsimile machine can transmit a file on the data exchange network by facsimile or forward the file via the data exchange network. However, accompanying such an improvement in convenience, a volume of files which can be handled has increased. In addition, for various managements, there are cases in which it is necessary to provide a restriction. For example, for each user, files which can be handled by the user are narrowed down to some degree, or a range of files which can be handled by the user is limited. Furthermore, even in case a transmitter device which can handle a file has multiple functions, a recipient device which receives the file does not necessary have multiple functions. As a result, there are cases in which the recipient device fails to receive the file or even if the recipient device succeeds in receiving the file, the recipient device fails to use the received file.

As described above, in the case of placing some restrictions on the file to be handled, if the user is required to carry out an operation for the restriction each time when the user uses the device, operationality of the user is lost. Therefore, there is a demand for a device which can place a restriction on the file to be handled without losing the convenience of the user.

A digital MFP which is a communication device with a copy function, a facsimile function, a printer function and a scanner function, and a plurality of client devices such as a Personal Computer (PC) are connected via the LAN to form a LAN system. Such a LAN system is put into a practical use. In the conventional LAN system, a scanner of the digital MFP scans an image of an original document and converts the scanned image into image data. Then, the image data is stored into a memory box in an image memory corresponding to each of the client devices. In response to a forwarding instruction request from each of the client devices, the digital MFP fetches the image data from the memory box in the image memory and forwards the image data to a corresponding client device via the LAN.

There is proposed an image forming device which can execute a process for transmitting by a facsimile machine, a document stored in a computer connected to a network. Specifically, the image forming device executes a document file selecting process, a document file forwarding process and a document file transmitting process. In the document file selecting process, the image forming device downloads via the network, a list of names of document files stored in each computer. Then, in accordance with the list, the image forming device selects a desired document file. In the document file forwarding process, the image forming device downloads the selected document file from each computer via the LAN. In the document file transmitting process, the image forming device transmits the downloaded document file to the facsimile machine via the LAN, and the transmitted document file is transmitted from the facsimile machine to a desired destination via a public line.

In the conventional digital MFP, one of the image data of the original document scanned by the scanner and the image data of the shared file in the terminal device connected to the LAN can be transmitted by facsimile. However, there is a drawback that the two kinds of image data cannot be combined and transmitted by facsimile.

### SUMMARY OF THE INVENTION

The present invention has been made in consideration to the above-described circumstances. An advantage of the present invention is to provide a communication device which reduces the labor of a user required for an operation for specifying data without losing convenience of the data, and a data conversion device which converts the data into data which can be used in such a communication device.

Another advantage of the present invention is to provide a communication device which can set a condition in advance and limit transmission of a file in accordance with the condition without losing operationality of a user.

Another advantage of the present invention is to provide a communication device which can combine image data of a scanned original document and image data of data of a shared file in a terminal device connected to a LAN and transmit the combined image data by facsimile.

According to an aspect of the present invention, a communication device includes a communication unit, an input unit, a retrieving unit and a control unit. The communication unit carries out communication with another communication device through a network. The input unit inputs an identifier for specifying a file and a transmission destination of the file. With the identifier input by the input unit as a retrieval key, the retrieving unit retrieves a file having the identifier from files on the network. The control unit controls to transmit the retrieved file to the transmission destination. The identifier can be associated with the file. However, for example, when the identifier is included in the file, at transmission, the identifier can be deleted from the retrieved file and then the file can be transmitted. When a plurality of files are retrieved, one file or a plurality of files selected by the input unit can be transmitted.

According to an aspect of the present invention, a data conversion device converts a file into a file which can be used in the above-described communication device. The data conversion device includes a conversion unit, an adding unit and a transferring unit. The conversion unit converts a content of a file into a data format appropriate for facsimile transmission. The adding unit adds an identifier to the converted data. The transferring unit transfers to another device or stores in the data conversion device, the data added with the identifier as the file.

According to an aspect of the present invention, a communication device includes a communication unit, an input unit, a retrieving unit, a display unit, a selecting unit, a determining unit and a control unit. The communication unit carries out communication through a network. The input unit inputs a retrieval condition and a transmission destination. The retrieving unit retrieves files on the network. The display unit displays the retrieval result. The selecting unit selects a transmission file from the retrieval result. The determining unit determines whether or not to permit transmission of the selected file in accordance with a given transmission determining condition. The control unit transmits to the transmission destination, the file determined to be transmitted by the determining unit.

According to an aspect of the present invention, a communication device is connected to a network to which at least one terminal device is connected. The communication device includes an image scanning unit, a retrieving unit and a transmission unit. The image scanning unit scans an image of an original document and converts the scanned image into image data. The retrieving unit retrieves and selects data of a shared file stored in at least one of the terminal device and the facsimile machine, and fetches the selected data. The transmission unit combines the converted image data and image data of the selected data into one combined image data and transmits the combined image data by facsimile.

According to the communication device of the present invention, without inputting a precise location of the file, just by inputting an identifier, the files on the network are retrieved. Therefore, labor of a user for the input operation and errors in the input operation can be reduced. If a file exists on the network, the file is not required to be stored in a specific information box or the like. Therefore, for example, by storing the file in a shared folder or the like, the file can be used easily for various purposes not limited to transmission.

According to the data conversion device of the present invention which converts a file into a file to be used in such a communication device, for example, just by building a program in driver software or the like of a PC, a file can be converted into a file added with an identifier. As a result, when the user instructs an output of a file, the file can be converted easily into a file which can be used in the communication device of the present invention.

According to the present invention, when transmitting a file on the network, a determination is made automatically as to whether or not the file can be transmitted in accordance with the transmission determining condition. Then, the file which transmission is determined to be permitted is transmitted. Therefore, by setting the transmission determining condition in advance, without losing the operationality of the user, transmission files can be restricted. As the transmission determining condition, other than a condition dependent on a device such as a communication protocol, a condition which can be used for various purposes such as management of the user or the device can be set. Then, in accordance with the set transmission determining condition, the transmission of the file can be restricted automatically.

According to an aspect of the present invention, a facsimile machine includes a retrieving unit and a transmission unit. The retrieving unit retrieves and selects data of a shared file stored in at least one of a terminal device and a communication device, and fetches the selected data. The transmission unit combines the converted image data and the image data of the selected data into one combined image data and transmits the combined image data by facsimile. Accordingly, the image data of the scanned original document and the image data of the data of the shared file in the terminal device connected to the network can be combined and transmitted by facsimile.

### BRIEF DESCRIPTION OF THE DRAWINGS

FIG. 1 is a block diagram showing an example of a system including a communication device and a data conversion device according to a first embodiment of the present invention.

FIG. 2A and FIG. 2B show examples of a method for adding an identifier to a file.

FIG. 3 is a flowchart showing an example of an operation carried out by a driver 21.

FIG. 4 is a flowchart showing an example of a transmission operation using the identifier carried out by a communication device

FIG. 5 is a block diagram showing a communication device according to a second embodiment of the present invention.

FIG. 6 shows a first example of transmission determining conditions.

FIG. 7 shows a second example of the transmission determining conditions.

FIG. 8 shows a third example of the transmission determining conditions.

FIG. 9 is a flowchart showing an example of an operation carried out by a communication device 100.

FIG. 10 is a block diagram showing a configuration of a LAN system including a digital MFP 1020 which is a communication device having a copy function, a facsimile function, a printer function and a scanner function according to a third embodiment of the present invention.

FIG. 11 is a block diagram showing a configuration of a client PC 1030 of FIG. 10.

FIG. 12 is a block diagram showing a configuration of the digital MFP 1020 of FIG. 10

FIG. 13 is a front view showing a display unit 1004 and an operation unit 1005 of the digital MFP 1020 of FIG. 10.

FIG. 14 is a flowchart showing a facsimile transmission process carried out by a main control unit 1001 of the digital MFP 1020 of FIG. 10.

FIG. 15A is a front view showing an example of a first image displayed on the display unit 1004 when the facsimile transmission process of FIG. 14 is executed by the digital MFP 1020 of FIG. 10.

FIG. 15B is a front view showing an example of a second image.

FIG. 15C is a front view showing an example of a third image.

FIG. 16A is a front view showing an example of a fourth image displayed on the display unit 1004 when the facsimile transmission process of FIG. 14 is executed by the digital MFP 1020 of FIG. 10.

FIG. 16B is a front view showing an example of a fifth image.

FIG. 16C is a front view showing an example of a sixth image.

FIG. 17A is a front view showing an example of a seventh image displayed on the display unit 1004 when the facsimile transmission process of FIG. 14 is executed by the digital MFP 1020 of FIG. 10.

FIG. 17B is a front view showing an example of an eighth image.

FIG. 18A is a front view showing an example of a ninth image displayed on the display unit 1004 when the facsimile transmission process of FIG. 14 is executed by the digital MFP 1020 of FIG. 10.

FIG. 18B is a front view showing an example of a tenth image.

FIG. 18C is a front view showing an example of an eleventh image.

FIG. 19A is a front view showing an example of a twelfth image displayed on the display unit 1004 when the facsimile transmission process of FIG. 14 is executed by the digital MFP 1020 of FIG. 10.

FIG. 19B is a front view showing an example of a thirteenth image.

### DETAILED DESCRIPTION OF THE PREFERRED EMBODIMENTS

### First Embodiment

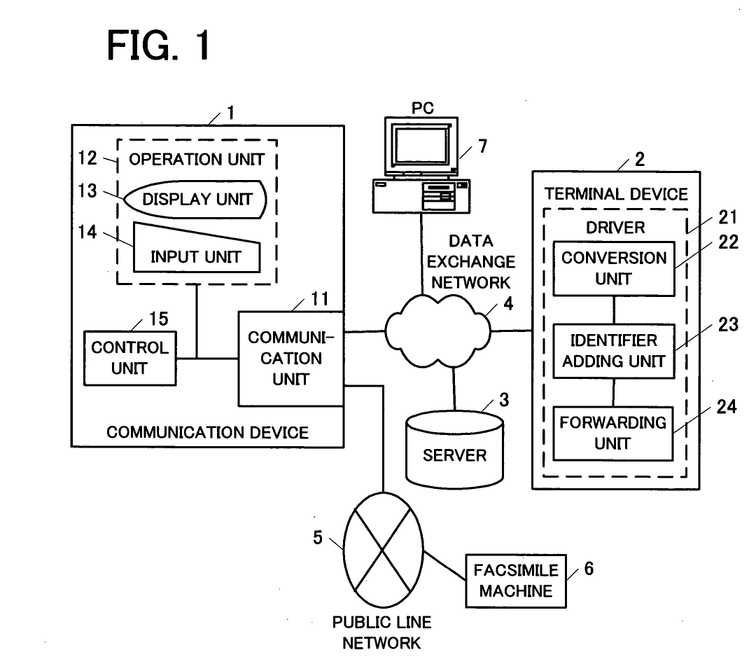

FIG. 1 is a block diagram showing an example of a system including a communication device and a data conversion device according to a first embodiment of the present invention. In the drawing, reference numeral 1 denotes a communication device, 11 denotes a communication unit, 12 denotes an operation unit, 13 denotes a display unit, 14 denotes an input unit, 15 denotes a control unit, 2 denotes a terminal device as a data conversion device, 21 denotes a driver, 22 denotes a conversion unit, 23 denotes an identifier adding unit, 24 denotes a forwarding unit, 3 denotes a server, 4 denotes a data exchange network and 5 denotes a public line network. Reference numerals 6 and 7 denote terminal devices to be transmission destinations. As an example, the terminal device 6 is a facsimile machine and the terminal device 7 is a PC. In the example shown in FIG. 1, the communication device 1, the terminal device 2, the server 3 and the PC 7 are connected by the data exchange network 4 such as a LAN and the Internet in a manner capable of carrying out communication. The present invention is not limited to this example and various devices can be connected to the data exchange network 4. A device for storing a file to be described later is not limited to the devices shown in the drawings.

The communication device 1 carries out communication with another communication device. The communication device 1 includes the communication unit 11, the operation unit 12 and the control unit 15 or the like. The communication unit 11 carries out communication through at least the data exchange network 4 with another device connected to the data exchange network 4. In the example shown in FIG. 1, other than the data exchange network 4, the communication device 1 is also connected to the facsimile machine 6 through the public line network 5 in a manner capable of carrying out communication. The communication device 1 can be formed capable of carrying out communication by using other communication channels.

The operation unit 12 includes the display unit 13 and the input unit 14 or the like. The display unit 13 presents various pieces of information to a user. The input unit 14 accepts various inputs from the user. For example, from the operation unit 12, a transmission file can be designated or selected and a transmission destination of the file can be input.

The control unit 15 controls each of the units of the communication device 1. The control unit 15 implements various functions of the communication device 1. In particular, when executing a function for transmitting a file, the control unit 15 receives an identifier for specifying the transmission file from the input unit 14 of the operation unit 12. Then, with the identifier as a retrieval key, the control unit 15 retrieves a file having the identifier on the data exchange network 4 through the communication unit 11. Then, the control unit 15 controls to transmit the retrieved file to the destination designated by the input unit 14. Further, instead of carrying out the retrieving process by the control unit 15, the actual retrieving process can be requested to another device connected to the data exchange network 4. When a plurality of files are retrieved in the retrieving process, the retrieval result is displayed on the display unit 13 of the operation unit 12. Then, the file selected by the input unit 14 (or all of the files) can be set as a transmission file.

The terminal device 2 is a network terminal used by the user. The terminal device 2 can create and edit a file. With respect to the file which transmission is instructed from the communication device 1, a conversion of a file format and storing or forwarding of the file are carried out by using the driver 21. The driver 21 includes functions of the data conversion device of the present invention. The driver 21 includes the conversion unit 22, the identifier adding unit 23 and the forwarding unit 24 or the like. The conversion unit 22 converts a file format of a transmission file into a format appropriate for facsimile transmission or the like.

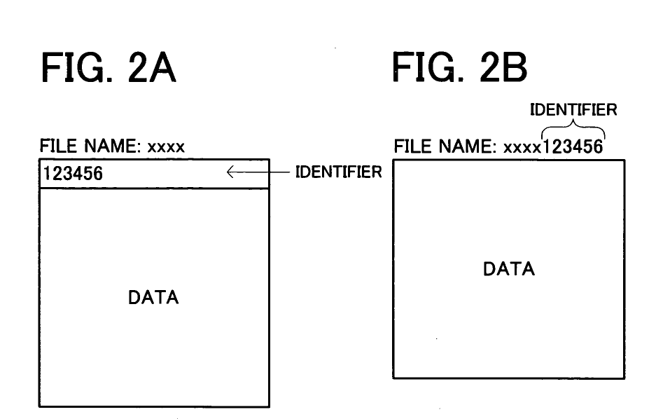

The identifier adding unit 23 adds an identifier to the file converted by the conversion unit 22. The identifier can be added automatically or can be added by receiving an input from the user. FIG. 2A and FIG. 2B show examples of a method for adding the identifier to the file. For example, as shown in FIG. 2A, the identifier can be embedded in data of the file. In this case, when transmitting the file by the communication device 1, the embedded identifier is deleted and then the file is transmitted. Alternatively, as shown in FIG. 2B, the identifier can be embedded as a part of a file name. In this case, the file can be used as it is.

The forwarding unit 24 forwards the file added with the identifier to a designated device or stores the file in a storage unit (not shown) of the terminal device 2. When forwarding the file, for example, the file can be forwarded to and stored in the server 3 and used later on. Alternatively, the file can be forwarded directly to the communication device 1.

Next, an example of an operation carried out in a system including the communication device and the data conversion device according to the first embodiment of the present invention will be described. First, the user creates and edits a transmission file by using a certain application program. Then, the user carries out an operation to write out the file by using the driver 21.

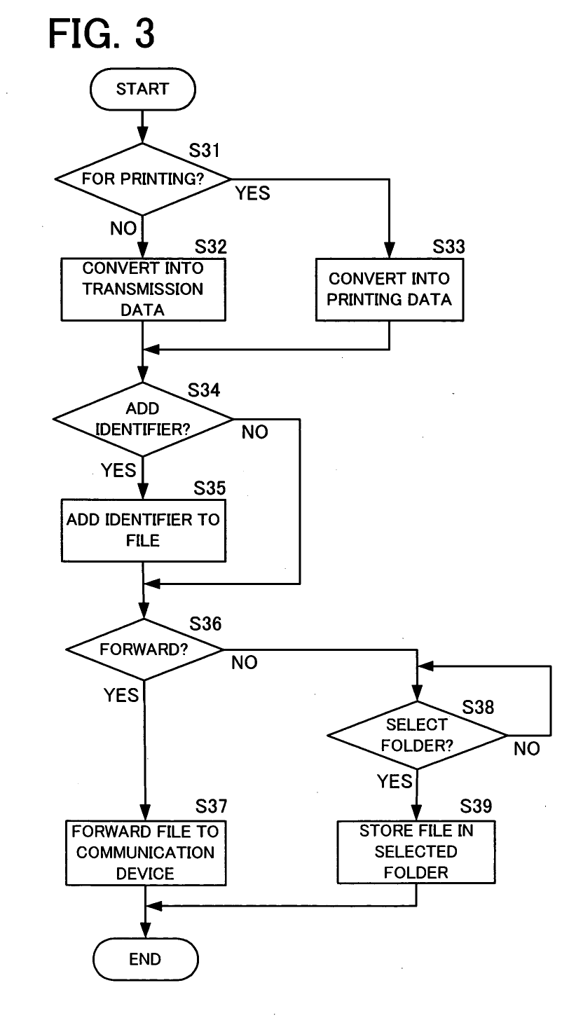

FIG. 3 is a flowchart showing an example of an operation carried out by the driver 21. The driver 21 includes a function for converting into a file format for transmission and a function for converting into a file format for printing.

When the driver 21 is started, at step S31, a determination is made as to whether to carry out a conversion into the file format for transmission or to carry out a conversion into the file format for printing. The determination of step S31 determines the instruction from the user. When the conversion into the file format for transmission is instructed, at step S32, the conversion unit 22 converts the file into the file format for transmission. When the conversion into the file format for printing is instructed, at step S33, the conversion unit 22 converts the data into the file format for printing. In either case, the process proceeds onto step S34.

At step S34, a determination is made as to whether or not to embed an identifier. The determination of step S34 is carried out in accordance with a direct instruction from the user or in accordance with various settings made by the user. The identifier is used for designating a file in the communication device as described above. When a determination is made to embed the identifier, at step S35, the identifier adding unit 23 adds an identifier to the file converted at step S32 or step S33. For example, as described in FIG. 2A, the identifier can be embedded in the file, or as described in FIG. 2B, the identifier can be embedded in the file name. Further, the identifier can be generated and added automatically, or the identifier can be added in accordance with the instruction from the user. In case the identifier is generated automatically, the identifier is notified to the user so that the file can be transmitted from the communication device 1 by using the identifier.

At step S36, a determination is made regarding a setting of a forwarding destination. For example, when the setting is a setting to forward the file to the communication device 1, at step S37, the forwarding unit 24 forwards the file processed as described above to the communication device 1. Accordingly, an instruction can be made to the communication device 1 to transmit the file immediately. Alternatively, an instruction can be made to the communication device 1 to carry out a printing operation by a printing function (not shown). When forwarding the file to another device such as a printer and an MFP, the processes are carried out in the same manner.

When an instruction is made to store the data and not to forward the data, the driver 21 receives an instruction of a storage folder from the user (S38). At step S39, the forwarding unit 24 stores the file in the instructed folder. The folder to store the file can be a storage unit of the terminal device 2, or can be the server 3, the communication device 1 or other devices. For example, even in case of the transmission data, the transmission data is not required to be stored in a specific location as in a conventional device.

The transmission file stored in the above-described manner can be transmitted later from the communication device 1. In this case, with respect to the file added with the identifier, without inputting a precise location, the transmission can be instructed by the input of the identifier. An example of the operation carried out in this case will be described.

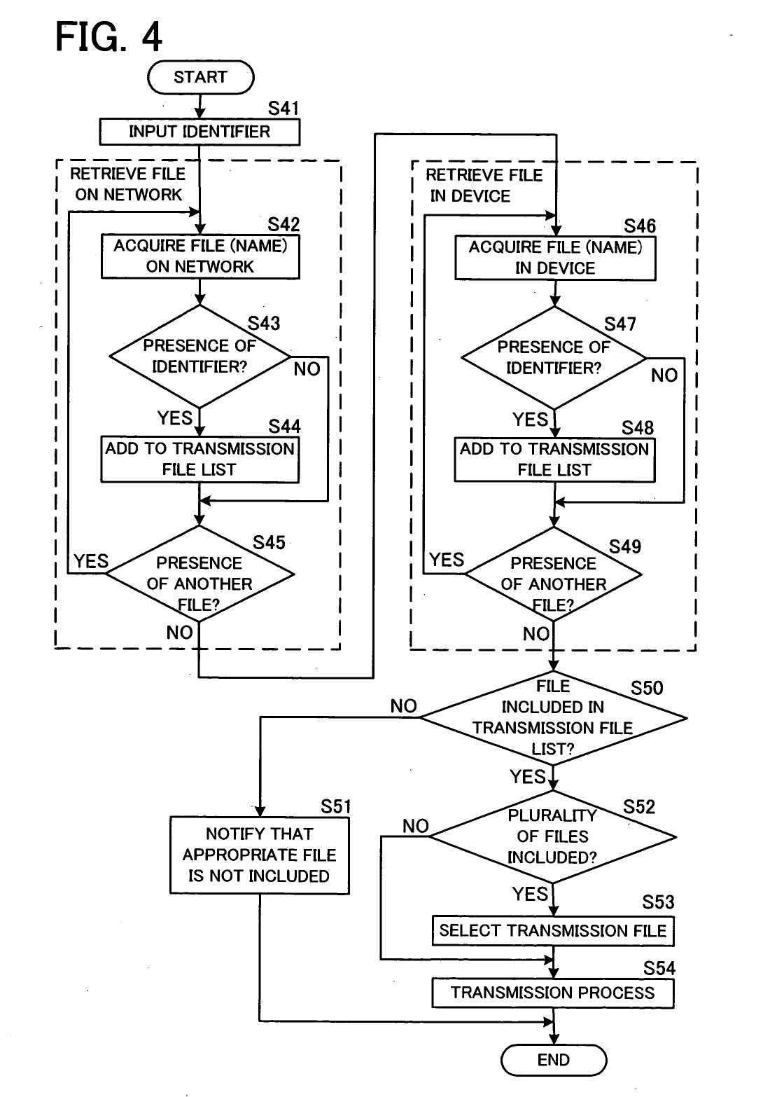

FIG. 4 is a flowchart showing an example of a transmission operation using the identifier carried out by the communication device. First, at step S41, an identifier as the retrieval key is input from the input unit 14 of the operation unit 12.

When the identifier is input, at step S42 through step S45, with the input identifier as the retrieval key, a file on the data exchange network 4 is retrieved. At step S42, a file or a file name on the data exchange network 4 is acquired. At step S42, in case the identifier is embedded in the data of the file as shown in FIG. 2A, the data of the file can be acquired. In case the identifier is embedded in the file name as shown in FIG. 2B, the file name can be acquired. Then, at step S43, a determination is made as to whether or not the input identifier, which is the retrieval key, is embedded in the file or the file name. When the identifier is embedded, at step S44, the file is added to a transmission file list as a transmission file. When the identifier of the retrieval key is not embedded, the process proceeds onto step S45. At step S45, a determination is made as to whether or not there is another unprocessed file. When there is another file, the process returns to step S42 and the retrieving process is carried out for the other file.

At a point of time when there are no more unprocessed files, the retrieving process of the files on the data exchange network 4 is completed. At the completion, the files that have been retrieved up to this point of time are registered with the transmission file list. Further, the retrieving process of the file on the data exchange network 4 can be carried out within a preset range. The retrieving process can be requested to another device or can be executed by inquiring with another device.

A file stored in the communication device 1 is also retrieved. At step S46, a file or a file name stored in a storage unit (not shown) of the communication device 1 is acquired. At step S47, a determination is made as to whether or not the input identifier, which is the retrieval key, is embedded in the file or the file name. When the identifier is embedded, at step S48, the file is added to the transmission file list as a transmission file. At step S49, a determination is made as to whether or not there is another unprocessed file in the communication device 1. When there is another file, the process returns to step S42 and the retrieving process is carried out for the other file. As described above, the retrieving process is carried out also for the file stored in the communication device 1. The file, which is added with the identifier input at step S41, is added to the transmission file list.

When the retrieving process of the files has been completed, at step S50, the transmission file list is referenced and a determination is made as to whether or not a transmission file is included. When a transmission file is not retrieved, at step S51, a fact that a transmission file is not included is displayed on the display unit 13 of the operation unit 12 to notify the fact to the user.

When a transmission file is included in the transmission file list, at step S52, a determination is made as to whether or not a plurality of transmission files are included in the transmission file list. When there is only one transmission file, the file is determined to be transmitted. Then, at step S54, the file is transmitted to a destination designated by the user from the input unit 14 in advance or at this point of time. In this case, for example, when the identifier is embedded in the data of the file as shown in FIG. 2A, the identifier is deleted from the data and then the file is transmitted.

When a plurality of files are included in the transmission file list, for example, a list of the files is displayed on the display unit 13 of the operation unit 12 to be presented to the user. Then, at step S53, a transmission file is selected. Of course, all of the files can be selected. The selected file is determined to be transmitted and at step S54, the above-described transmission process is executed. Further, when no file is selected, the process ends without carrying out the transmission process.

As described above, at transmission, the user is not required to accurately input a long character string for specifying the location of the file. Just by inputting the identifier, the retrieving process can be carried out automatically within a certain range and the transmission file can be specified. In general, the character string of the identifier is shorter. Therefore, the effort of the user for specifying the transmission file can be reduced. In addition, mistakes made in the input operation can be reduced. Furthermore, when a plurality of files are retrieved, a desired file can be selected from the plurality of the files.

Since the retrieving process is carried out automatically, if the file is located within the retrieval range, the file can be located at any location. As a result, the degree of freedom in handling of the file can be improved. In addition, convenience as the file can be maintained, for example, by sharing the same file with a plurality of users.

### Second Embodiment

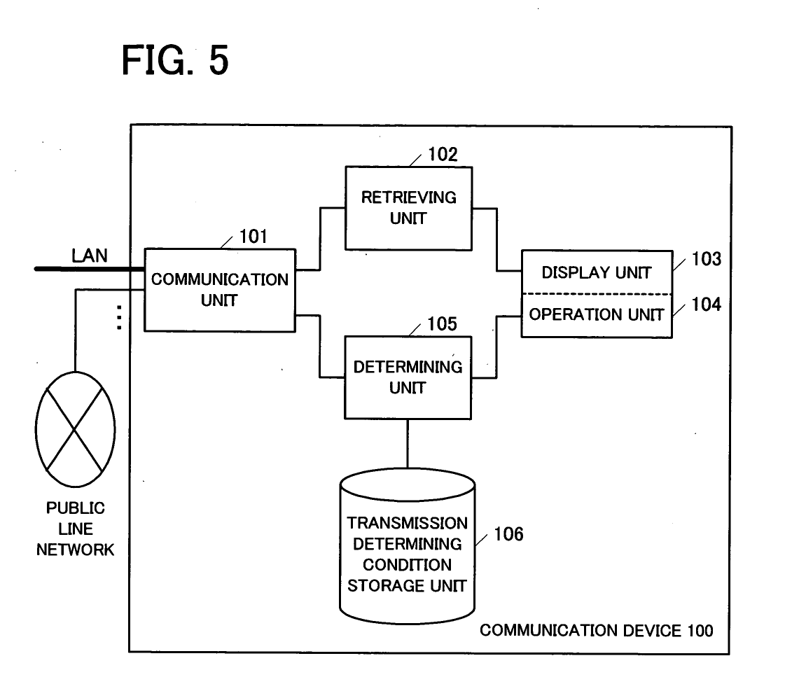

FIG. 5 is a block diagram of a communication device 100 according to a second embodiment of the present invention. In FIG. 5, reference numeral 101 denotes a communication unit, 102 denotes a retrieving unit, 103 denotes a display unit, 104 denotes an operation unit, 105 denotes a determining unit and 106 denotes a transmission determining condition storage unit. The communication device of the present invention is connected to at least a data exchange network such as the LAN and the Internet in a manner capable of carrying out communication. The communication device of the present invention can access a file on the data exchange network such as a shared file. Of course, the communication device can be formed capable of carrying out communication by using another network such as a public line network.

As described above, as the communication device, the communication unit 101 can carry out communication by using various protocols through the network capable of carrying out the communication. The communication unit 101 also transmits a file which transmission is determined to be permitted by the determining unit 105 as to be described later.

The retrieving unit 102 retrieves a file on the network via the communication unit 101. With respect to the retrieving process, a retrieval condition can be set in advance or at a point of time when the retrieving process is instructed. As the retrieval condition, various conditions can be set by using, for example, information relating to the file, information relating to a storage location or information relating to the user (transmitter) who instructs the retrieving process. Further, the information relating to the file can be a file name, a file size, a file type, character string information in the file, owner information and creator information or the like. The information relating to the storage location can be a folder name, a device name and a network address or the like. A plurality of retrieval conditions can be set. Then, a retrieval condition can be selected appropriately and used, or can be used by a combination of the conditions. Further, a retrieval condition that has been used for once can be stored, and can be used again later as it is or by adding corrections. There are cases in which a file retrieved in the retrieving process receives a restriction of the system, for example, the file being limited to a shared file.

The display unit 103 displays the retrieval result of the retrieving unit 102. When displaying, the result can be displayed as a list by appropriately using items of information relating to the retrieved file, such as a file name, a file size, a date and time of creation (update) and an owner. The items to be displayed can be set. Instead of displaying the retrieval result as a list, a content of the file can be displayed or thumbnails of the content of the file can be displayed as a list.

The operation unit 104 accepts various inputs from the user. In particular, the operation unit 104 can be used for selecting a transmission file from the retrieval result displayed on the display unit 103. Moreover, various operations can be carried out from the operation unit 104. For example, a transmission destination of the selected file can be input.

The determining unit 105 determines whether or not to permit transmission of the transmission file selected by the operation unit 104 in accordance with a transmission determining condition stored in the transmission determining condition storage unit 106. The communication unit 101 transmits to a destination, the file which transmission is determined to be permitted. When determining whether or not to permit the transmission, in case a plurality of transmission determining conditions are stored in the transmission determining condition storage unit 106, the determination can be carried out in accordance with all or a part of the plurality of the transmission determining conditions. When carrying out the determination in accordance with a part of the transmission determining conditions, the determination can be carried out by using the transmission determining conditions set in advance. The determination of whether or not to permit the transmission carried out by the determining unit 105 can be set to be carried out only when there is a setting to carry out the determination in accordance with the transmission determining condition.

The transmission determining condition storage unit 106 stores the transmission determining condition set in advance. The transmission determining condition can be set according to a communication protocol used in the transmission of the file, according to a transmission destination of the file, according to a transmitter of the file or according to information relating to the selected file. Further, as the information relating to the file, the transmission determining condition including a file type, a file size, a file owner and location information of the file or the like can be set. Such a transmission determining condition stored in the transmission determining condition storage unit 106 is used for determining whether or not to permit the transmission of the file by the determining unit 105.

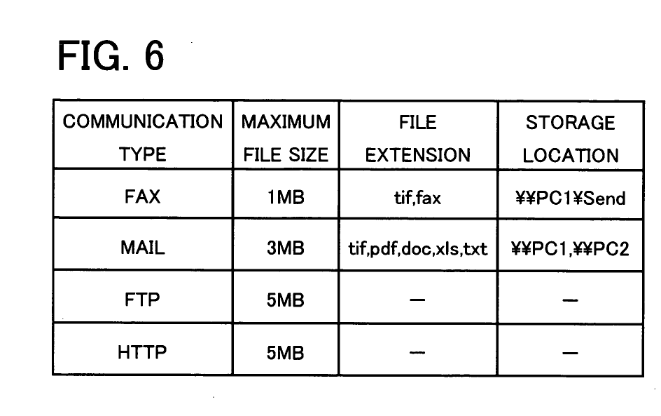

FIG. 6 shows a first example of the transmission determining conditions. In the example shown in FIG. 6, for each communication type, conditions for determining whether or not to permit the transmission of the file are shown. In the example shown in FIG. 6, the conditions are set for a maximum file size, a file extension and a storage location. For example, conditions of a first line show the conditions for transmitting a file by facsimile. According to the conditions of the first line, a transmission of a file which a file size is 1 megabyte (MB), which “tif” or “fax” is added as an extension and which is stored in “¥¥PC1¥Send” is determined to be permitted. When transmitting a file by facsimile, only in case the conditions of the first line are satisfied, the file can be transmitted. In the same manner, a second line shows conditions for when transmitting a file by electronic mail. A third line shows conditions for when transmitting a file by the File Transfer Protocol (FTP). A fourth line shows conditions for when forwarding a file by the Hyper Text Transfer Protocol (HTTP).

Of course, if there exist other communication methods, the transmission determining conditions can be registered also for the other communication methods. Further, in the example shown in FIG. 6, as the conditions, restrictions are provided for the maximum file size, the file extension and the storage location. However, the present invention is not limited to this example and any condition can be provided.

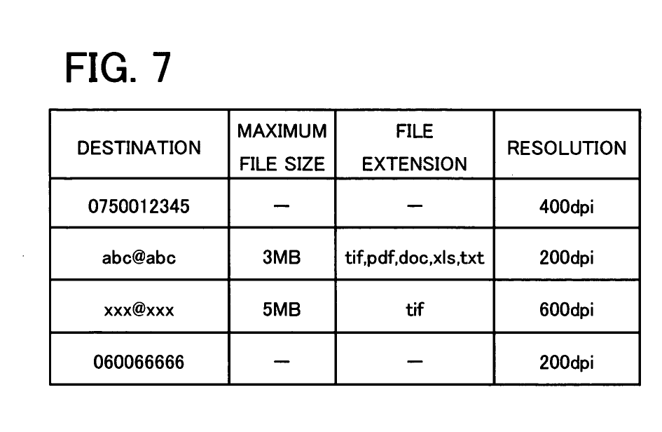

FIG. 7 shows a second example of the transmission determining conditions. The example shown in FIG. 7 shows the transmission determining conditions provided for each destination. In the example shown in FIG. 7, conditions are provided for a maximum file size, a file extension and resolution. For example, conditions of a first line show conditions when transmitting a file to a destination (transmission destination) of a telephone number “0750012345”. The conditions are not provided for the maximum file size and the file extension. A condition is provided that the resolution is 400 dpi (dots per inch) or lower. In the same manner, a second line shows conditions for when transmitting a file to a destination with an electronic mail address “abc@abc”. A third line shows conditions for when transmitting a file to a destination with an electronic mail address “xxx@xxx”. A fourth line shows conditions for when transmitting a file to a destination with a telephone number “060066666”.

Further, instead of setting the conditions individually for each destination, the same condition can be set for a plurality of destinations or a condition can be set for each group of destinations. For example, in case the destinations are electronic mail addresses, the condition can be set for each domain. In case the destinations are telephone numbers, the condition can be set for each area code or the like. In the example shown in FIG. 7, telephone numbers and electronic mail addresses are shown as the destinations. However, the present invention is not limited to these examples. For example, a destination can be specified by an extension number, an Internet Protocol (IP) address, a HTTP address or the like. For the conditions, conditions other than the maximum file size, the file extension and the resolution can be provided.

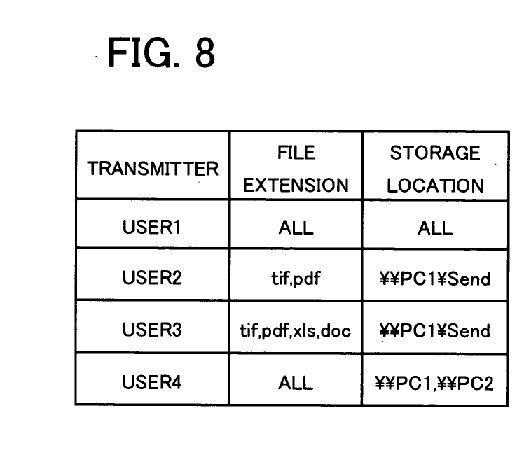

FIG. 8 shows a third example of the transmission determining conditions. The example shown in FIG. 8 shows the transmission determining conditions provided for each transmitter. In the example shown in FIG. 8, the conditions are provided for a file extension and a storage location of the file. For example, a first line shows conditions for when transmitting a file by a “user 1”. According to the conditions of the first line, the user 1 can transmit all files. A second line shows conditions for when transmitting a file by a “user 2”. According to the conditions of the second line, a file which “tif ” or “pdf ” is added as the extension and which is stored in “¥¥PC1¥Send” can be transmitted. A third line shows conditions for when transmitting a file by a “user 3”. A fourth line shows conditions for when transmitting a file by a “user 4”. According to the conditions of the fourth line, a condition is provided only for the storage location, and a file which is stored in “¥¥PC1” and “¥¥PC2” can be transmitted.

Also in this case, a condition can be set for each user or a condition can be set for each group of users. Other than the file extension and the storage location of the file, various conditions can be provided as the conditions.

In the above-described examples shown in FIG. 6 through FIG. 8, the transmission determining conditions are set for each communication type, each destination and each transmitter, respectively. The transmission determining conditions can be set for other items. For example, the transmission determining conditions can be set for each item of the information relating to the file such as the file type and the storage location of the file.

Including the transmission determining conditions shown in FIG. 6 through FIG. 8 and the transmission determining conditions set for other items, the transmission determining conditions can be set by combining the conditions appropriately. For example, when using the transmission determining conditions shown in FIG. 6 through FIG. 8 by combining the conditions, in case the user 2 carries out facsimile transmission of a file to “0750012345”, the file can be transmitted if the storage location of the file is “¥¥PC1¥Send”, the file extension is “tif”, the file size is 1 MB or less and the resolution is 400 dpi or lower. In case one of the conditions is not satisfied, the file cannot be transmitted.

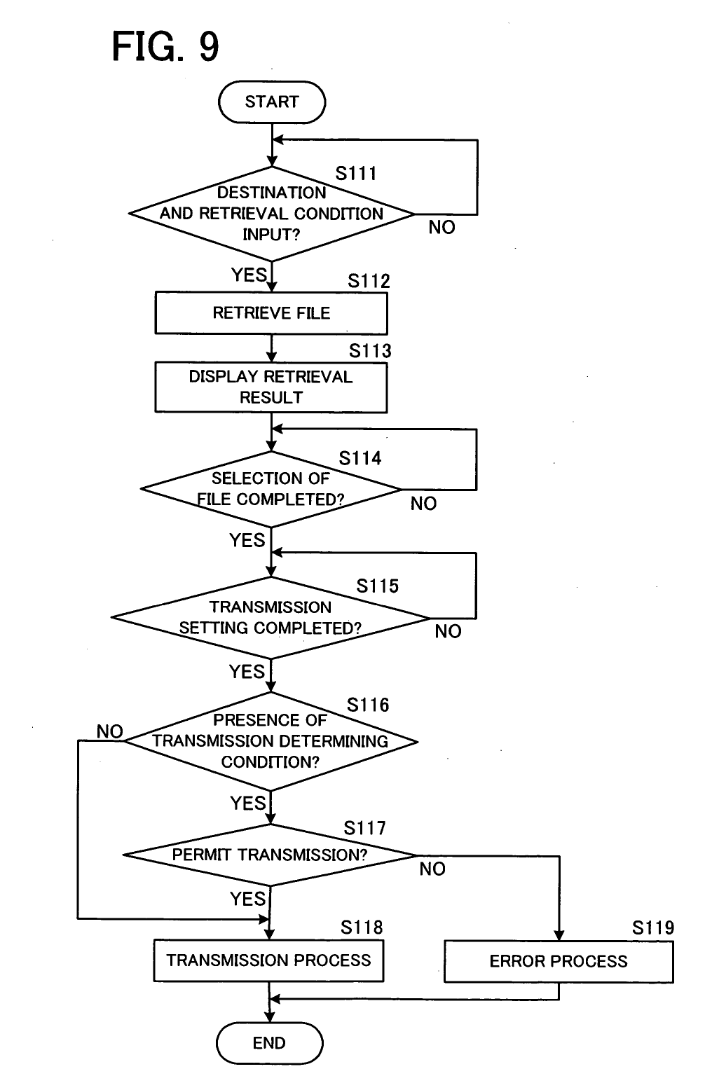

FIG. 9 is a flowchart showing an example of an operation carried out by the communication device according to the second embodiment of the present invention. When transmitting a file, first, the user retrieves a transmission file. For this purpose, the user inputs a retrieval condition and a transmission destination from the operation unit 104. As the retrieval condition, a general retrieval formula or the like can be input, or the retrieving process can be carried out by inputting a simple initial character, several initial characters or an abbreviation. Moreover, a storage location of the file and the file name for uniquely specifying the file can be designated.

At step S111, a determination is made as to whether or not the retrieval condition and the transmission destination have been input by the user. Until the retrieval condition is input, the process is suspended. When the retrieval condition has been input, at step S112, the retrieving unit 102 retrieves a file on the network in accordance with the given retrieval condition. Then, at step S113, the retrieval result is displayed on the display unit 103.

From the retrieval result displayed on the display unit 103, the user selects a transmission file from the operation unit 104. At step S114, a determination is made as to whether or not the selection of the transmission file has been completed. Until the selection of the transmission file by the user is completed, the process is suspended. When the transmission file has been selected, the user carries out various settings for the transmission process. For example, the user can set a transmission destination or set various communication attributes and user information or the like. These settings can also be made from the operation unit 104. At step S115, a determination is made as to whether or not these settings have been completed and the process is suspended until the settings are completed.

When the settings by the user have been completed, at step S116, an inquiry is made as to whether or not to carry out a determination of whether or not to permit transmission in accordance with the transmission determining condition. For example, an inquiry can be made as to whether or not the transmission determining condition is set, or whether or not a setting is made to carry out the determination. In case of not determining whether or not to permit the transmission, at step S118, the file selected by the user is transmitted to the destination input at step S111 and the transmission process ends.

In case of determining whether or not to permit the transmission, at step S117, in accordance with the transmission determining condition stored in the transmission determining condition storage unit 106, the determining unit 105 determines whether or not the transmission of the selected file can be permitted. When the transmission is determined to be permitted, at step S118, the selected file is transmitted. When the transmission is determined to be not permitted, at step S119, an error process is executed. For example, an error message is displayed on the display unit 103.

In case a plurality of files are selected, the determination of whether or not to permit the transmission can be carried out for each of the files. Moreover, a setting can be made in advance for an operation carried out when the transmission of a part of the files is determined to be not permitted. For example, all of the files can be set to be not transmitted, or only the files which the transmission is determined to be permitted can be set to be transmitted.

As described above, when transmitting a file, the determination of whether or not to permit the transmission of the file is carried out automatically in accordance with the transmission determining condition set in advance. Therefore, at transmission, the user is not required to carry out an operation for determining whether or not the transmission can be permitted. As a result, operationality of the user is not lowered. Moreover, by setting a restriction of the communication as the transmission determining condition, for example, by setting a restriction of a destination device or a restriction of the communication device or a system including the communication device as the condition, the transmission of the file exceeding the restriction can be prevented. Furthermore, by setting the transmission determining condition for each transmitter (user), the files transmitted by each user can be restricted. Moreover, the transmission determining condition can be set according to various purposes such as management of a device, and the transmission of the file can be restricted. Such various conditions can be set as the transmission determining condition. In accordance with the set transmission determining condition, a determination can be carried out automatically as to whether or not to permit the transmission of the file. Then, the transmission of the file which the transmission is determined to be not permitted can be restricted.

Further, the transmission determining condition for each transmitter can be determined before displaying the retrieval result on the display unit 103. Then, only a file which satisfies the transmission determining condition provided for the transmitter can be displayed. Alternatively, the transmission determining condition for each transmitter can be included in the retrieval condition. Then, when carrying out the retrieving process, only a file which satisfies the transmission determining condition provided for the transmitter can be retrieved.

### Third Embodiment

A third embodiment of the present invention will be described with reference to the drawings.

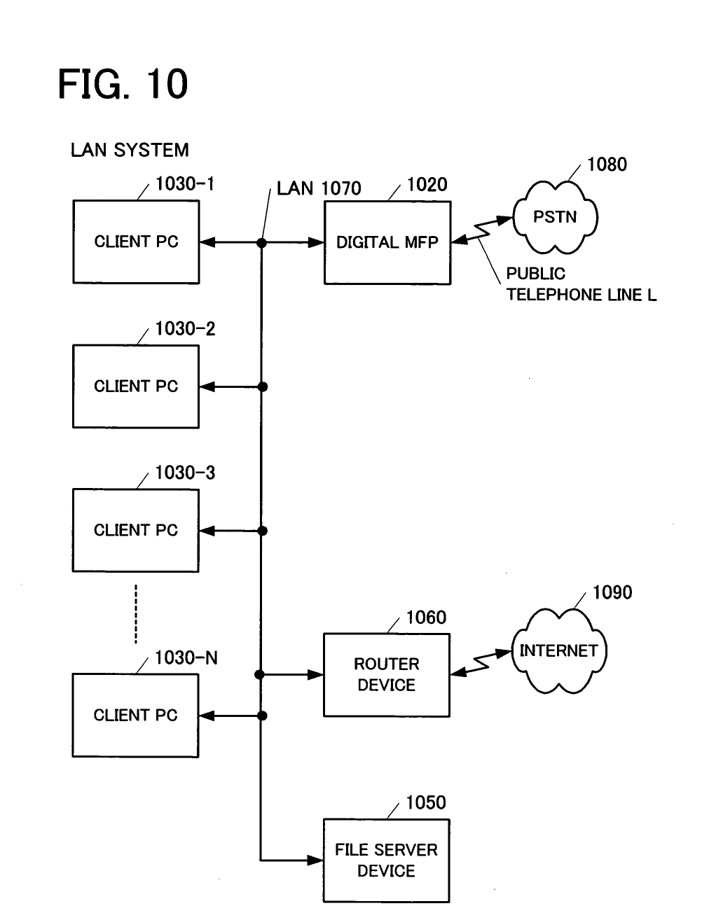

FIG. 10 is a block diagram showing a configuration of a LAN system including a digital MFP 1020 which is a communication device with a copy function, a facsimile function, a printer function and a scanner function according to the third embodiment of the present invention.

In the LAN system according to the third embodiment, N client PCs 1030-1 through 1030-N (hereinafter collectively referred to as the “client PC 1030”), the digital MFP 1020 and a router device 1060 are connected via a LAN 1070. The digital MFP 1020 is connected to a Public Switched Telephone Network (PSTN) 1080 via a public telephone line L. The router device 1060 is connected to the Internet 1090. Each client PC 1030 establishes a connection with the Internet 1090 via the router device 1060 or a mail server device (not shown). Accordingly, the client PC 1030 can browse a website and transmit and receive electronic mail. By accessing the digital MFP 1020, each client PC 1030 can use the copy function, the printer function, the scanner function and the facsimile function of the digital MFP 1020.

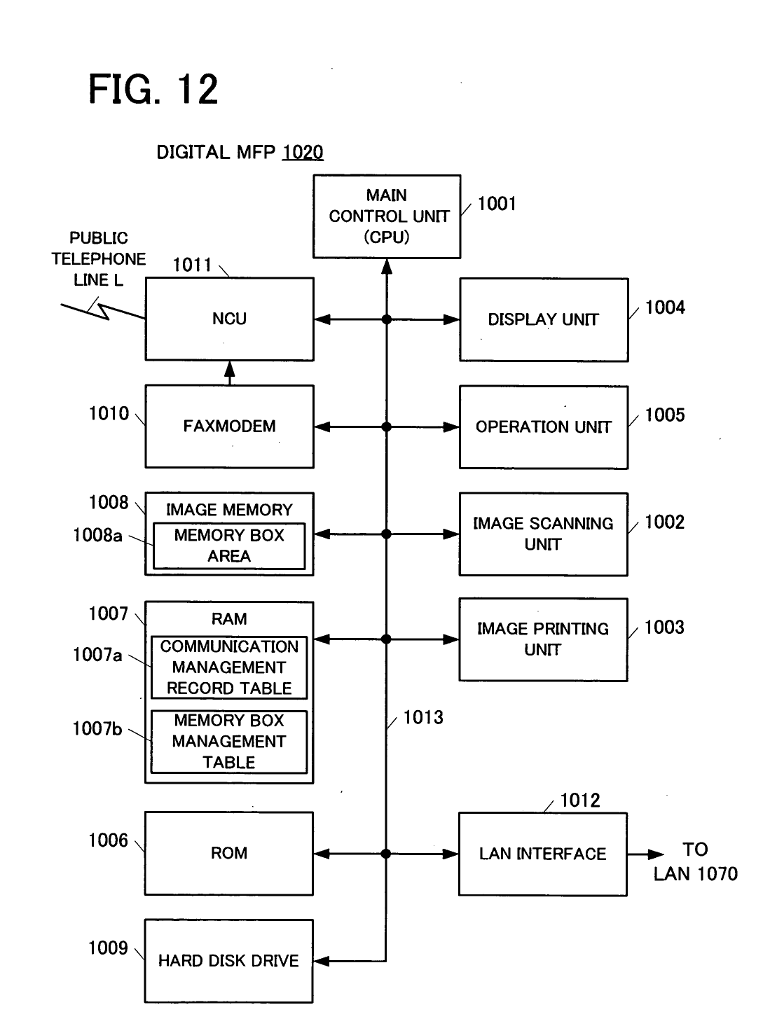

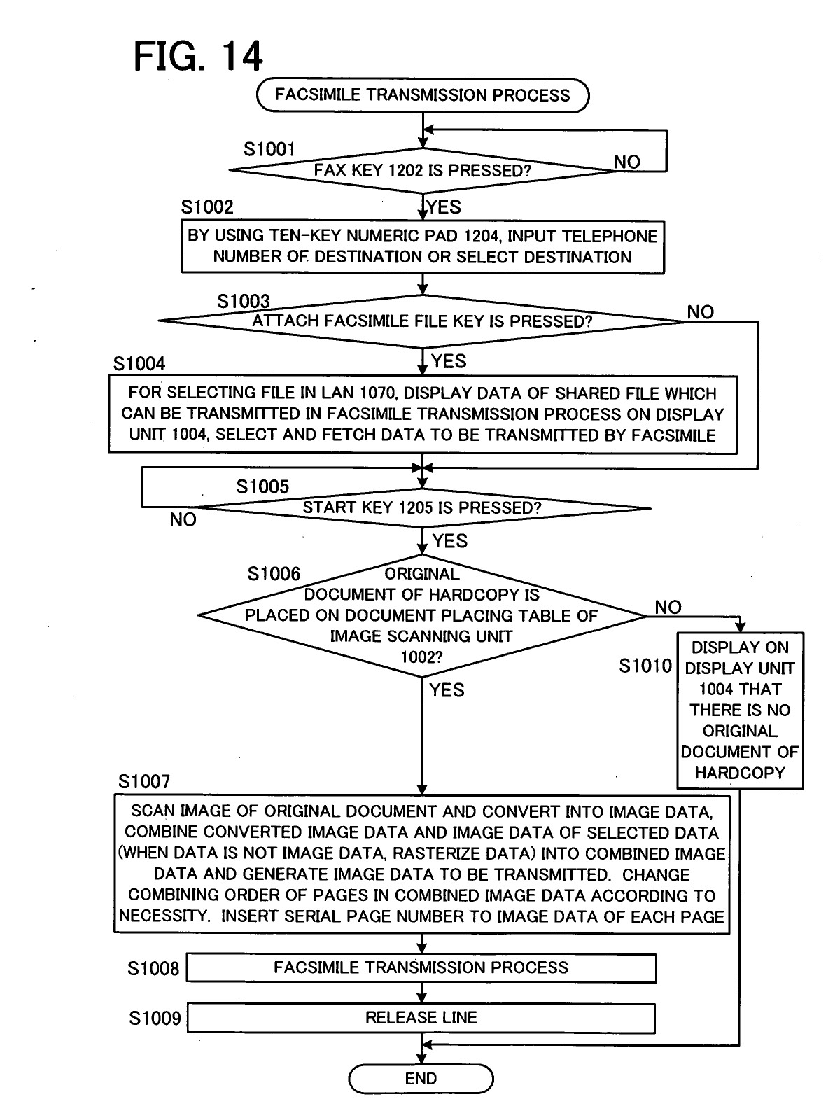

As shown in FIG. 12, the digital MFP 1020 according to the third embodiment includes an image scanning unit 1002 which scans an image of an original document and converts the scanned image into image data. Among data of a shared file stored in at least one of the client PC 1030 and the digital MFP 1020 connected to the LAN 1070, the digital MFP 1020 displays on a display unit 1004, only the image data which can be transmitted by facsimile in accordance with an extension of the data. Further, the shared file is data of a file in a shared folder stored in a storage device of devices 1030, 1020 and 1050 or the like (for example, hard disk drives 1108 and 1009) connected to the LAN 1070 and set accessible from another device. Then, among the displayed data, the user selects data of at least one shared file to be transmitted by facsimile (step S1004 of FIG. 14). Next, after fetching the selected data, the scanned image data and image data of the selected data are combined into one combined image data and transmitted by facsimile (steps S1007 through S1008). Further, when the data of the shared file is not image data, the data of the shared file is rasterized into image data of a prescribed format such as a Tagged Image File Format (TIFF) (step S1007). The combined image data includes a plural number of pages, and a combining order of the image data of each page is changed and set (step S1007). Furthermore, the combined image data includes a plural number of pages, and a serial page number is inserted to the image data of each page (step S1007). In addition, a detection is carried out for detecting whether or not there is an original document of an image to be scanned by the image scanning unit 1002 (step S1006). When there is no original document of the image, the process for combining the scanned image data and the image data of the selected data into one combined image data and transmitting the combined image data by facsimile is suspended (NO at step S1006 onto step S1010).

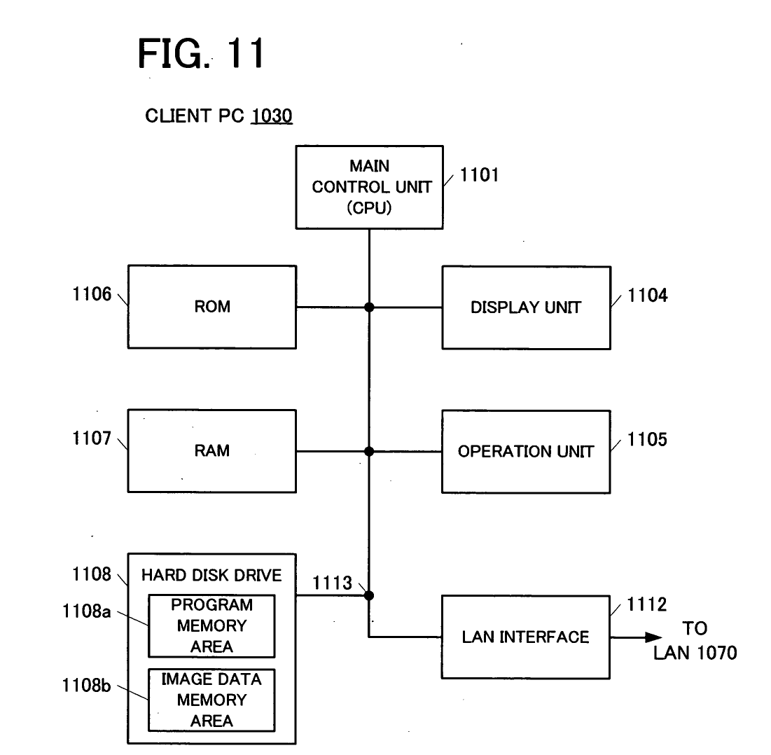

FIG. 11 is a block diagram showing a configuration of the client PC 1030 of FIG. 10.

In FIG. 11, the client PC 1030 is a terminal device which is a known PC. The client PC 1030 executes processes such as generating, printing and storing of image data or character data. In the third embodiment, as an example, the client PC 1030 stores image data scanned by a remote scanner, image data of an image of an original document generated by the client PC 1030 (for example, image data of an original document created by software of a word processor), and a data file created by an application program or the like. Then, the client PC 1030 provides the stored image data and the data file or the like to the LAN 1070 as a shared folder.

A main control unit 1101 is specifically formed of a Central Processing Unit (CPU). The main control unit 1101 is connected to each of following hardware components via a bus 1113 and controls each of the hardware components. The main control unit 1101 also executes various software functions to be described later. An image scanning unit and an image printing unit (not shown) are provided as an option in the client PC 1030. A display unit 1104 is a display device such as a Liquid Crystal Display (LCD) and a Cathode Ray Tube (CRT) display. The display unit 1104 displays an operational state of the client PC 1030, and also displays image data of transmission original document and received image data. An operation unit 1105 is a keyboard or the like and used for inputting character data and an instruction command.

A Read Only Memory (ROM) 1106 stores in advance various software programs necessary for the operation of the client PC 1030 and executed by the main control unit 1101. A Random Access Memory (RAM) 1107 is formed of a Static RAM (SRAM), a Dynamic RAM (DRAM), a Synchronous DRAM (SDRAM) or the like. The RAM 1107 is used as a working area of the main control unit 1101 and stores temporary data generated when a program is executed. The hard disk drive 1108 is a storage device having a recording medium and includes a program memory field 1108a or an image data memory field 1108b. The program memory field 1108a stores an application program to be executed and image data. The image data memory field 1108b stores image data.

In the above-described client PC 1030, when forwarding image data (which is scanned and converted by the image scanning unit 1002 of the digital MFP 1020 and stored in a corresponding memory box in the memory box field 1008a) into the client PC 1030, the main control unit 1101 of the client PC 1030 transmits a forwarding instruction requesting signal to the main control unit 1001 of the digital MFP 1020 via a LAN interface 1112 and the LAN 1070. Further, the forwarding instruction requesting signal includes instruction data instructing the corresponding memory box. In response to the forwarding instruction requesting signal, the client PC 1030 receives image data transmitted from the digital MFP 1020 via the LAN 1070 and stores the received image data in the hard disk drive 1108.

FIG. 12 is a block diagram showing a configuration of the digital MFP 1020 of FIG. 10.

In FIG. 12, the digital MFP 1020 includes a copy function, a printer function and a scanner function in addition to a conventional G3 method facsimile communication function. A main control unit 1001 is specifically formed of a CPU. The main control unit 1001 is connected to each of following hardware components via a bus 1013 and controls each of the hardware components. The main control unit 1001 also executes various software functions to be described later. An image scanning unit 1002 scans an original document by a scanner using a Charge Coupled Device (CCD) or the like, and outputs dotted image data converted into a binary of black and white. An image printing unit 1003 is an electro-photographic printer or the like. The image printing unit 1003 prints out as hardcopy, image data scanned and converted by the image scanning unit 1002 and image data received from another facsimile machine by facsimile communication. The image printing unit 1003 also prints out character data.

A display unit 1004 is a display device such as the LCD and the CRT display. The display unit 1004 displays an operational state of the digital MFP 1020, and also displays image data of a transmission original document and received image data. An operation unit 1005 includes character keys, a ten-key numeric pad for dialing, a speed-dial key, a one-touch dial key and various function keys or the like necessary for operating the digital MFP 1020. Further, by forming the display unit 1004 as a touch panel, a part or all of the various keys of the operation unit 1005 can be substituted.

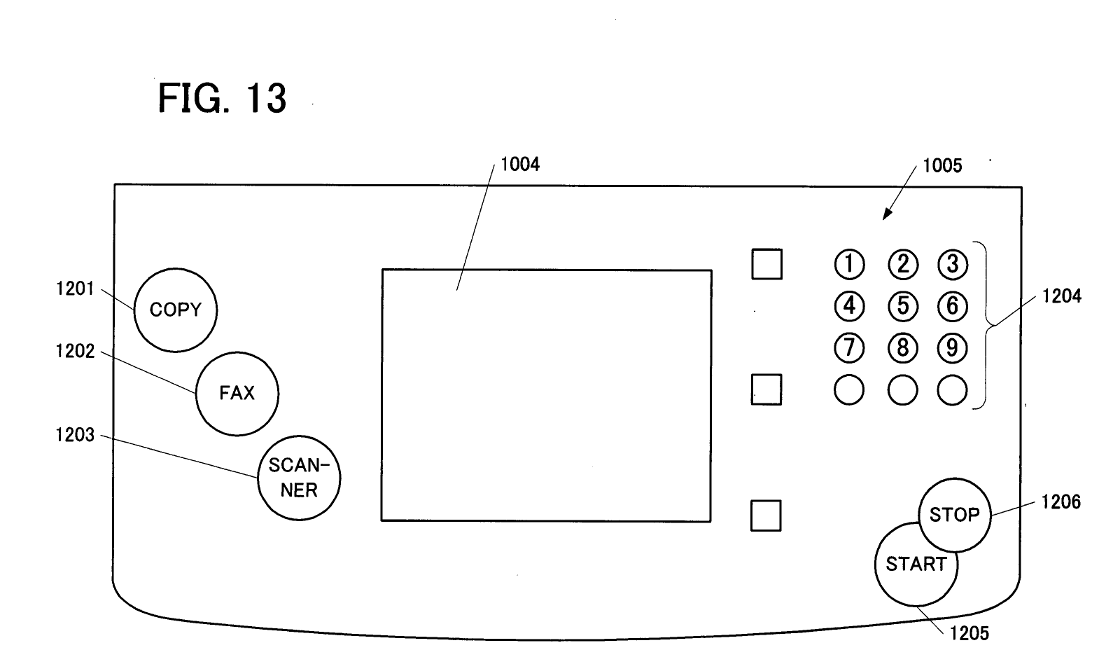

FIG. 13 is a front view showing an example of the display unit 1004 and the operation unit 1005. In FIG. 13, an LCD of the display unit 1004 is disposed at a center part of a panel of the operation unit 1005. To the left of the display unit 1004, a copy key 1201, a fax key 1202 and a scanner key 1203 are provided for designating a copy function, a facsimile function and a scanner function of the digital MFP 1020, respectively. To the upper-right side of the display unit 1004, a ten-key numeric pad 1204 is provided. To the lower side of the ten-key numeric pad 1204, a start key 1205 and a stop key 1206 are provided.

A ROM 1006 stores in advance various software programs necessary for the operation of the digital MFP 1020 and executed by the main control unit 1001. In the third embodiment, the ROM 1006 stores at least a program of a facsimile transmission process shown in FIG. 14. A RAM 1007 is formed of an SRAM, a DRAM, an SDRAM or the like. The RAM 1007 is used as a working area of the main control unit 1001 and stores temporary data generated when a program is executed. In case a flash memory is used for the RAM 1007, even when a power source is shut due to a power failure, a transferring of the device or the like, the content of the data in the RAM 1007 is not lost. The RAM 1007 stores a communication management record table 1007a and a memory box management table 1007b. The communication management record table 1007a stores a date and time of facsimile communication, a facsimile number of a destination, a transmitted or received number of pages, a communication result, a name of a person who output transmission image data acquired by comment data of a Print Job Language (PJL) (a transmitter name of a user at a transmitting end), a memory box number and a document name (text name). The memory box management table 1007b is a table for managing a memory box field 1008a in an image memory 1008. The memory box management table 1007b stores a memory box number given to the client PC 1030 connected to the LAN 1070 or a user of the client PC 1030, a recipient name of the user, a storage address of the image data in the image memory 1008 and an electronic mail address of the client PC 1030 or the user of the client PC 1030 (when necessary, for example, when notifying a reception of the facsimile).

The image memory 1008 is formed of a DRAM or the like. The image memory 1008 stores transmission image data or received image data, or scanned and converted image data. The image memory 1008 includes the memory box field 1008a which is sectioned into a plurality of memory boxes according to a plurality of client PCs 1030 or users of the client PCs 1030. Each of the client PCs 1030 forwards and temporarily stores in a corresponding memory box, image data transmitted and received by the facsimile function or image data scanned and converted by the scanner function or the copy function and image data used in the printer function. When fetching the image data from the memory box, by transmitting a forwarding instruction requesting signal, the client PC 1030 fetches the image data from the corresponding memory box and forwards the image data. Furthermore, the hard disk drive 1009 is a storage device having a recording medium and stores various data and programs.

A faxmodem 1010 is a modem connected to the public telephone line L and includes a function of a faxmodem for G3 facsimile communication or the like. A Network Control Unit (NCU) 1011 is a hardware circuit which releases and closes a direct current loop or the like of the analog public telephone line L and includes an automatic dial function. According to necessity, the NCU 1011 connects the faxmodem 1010 to the public telephone line L. The NCU 1011 detects an ID receiving terminal starting signal of a caller ID notification service and a general telephone call indication signal. In addition, according to necessity, the NCU 1011 can transmit a first response signal and a second response signal of the caller ID notification service. Further, the NCU 1011 can be connected a digital line (for example, an Integrated Services Digital Network (ISDN) line) of a baseband transmission method via a prescribed terminal adaptor and a Digital Service Unit (DSU).

Furthermore, a LAN interface 1012 is connected to the LAN 1070. The LAN interface 1020 receives a signal and data from the LAN 1070 and transmits a signal and data to the LAN 1070. The LAN interface 1020 executes an interface process relating to LAN communication such as a signal conversion and a protocol conversion.

According to the facsimile communication function of the digital MFP 1020, the image data forwarded from each of the client PCs 1030-1 through 1030-N or the dotted image data scanned by the image scanning unit 1002 is encoded by software in accordance with an encoding method such as a Modified Huffman (MH), a Modified Read (MR) and a Modified Modified Read (MMR) methods defined in a facsimile communication standard. Then, the encoded image data or the dotted image data is transmitted to the facsimile machine of the destination. Meanwhile, encoded image data received from the facsimile machine of the destination is decoded into image data by the software. Then, the image data is stored in the image memory 1008 and printed out by the image printing unit 1003 according to necessity.

FIG. 14 is a flowchart showing a facsimile transmission process executed by the main control unit 1001 of the digital MFP 1020 of FIG. 10.

In FIG. 14, first at step S1001, a determination is made as to whether or not the fax key 1202 of the operation unit 1005 has been pressed. Until the fax key 1202 is pressed, the process of step S1001 is repeated. When the fax key 1202 has been pressed, at step S1002, by using the ten-key numeric pad 1204, a telephone number of a destination is input or a destination is selected. At step S1003, a determination is made as to whether or not an attach facsimile file key displayed on the touch panel of the display unit 1004 has been pressed. When it is determined YES, the process proceeds onto step S1004. When it is determined NO, the process proceeds onto step S1005. At step S1004, for selecting a file in the LAN 1070, data (for example, in addition to TIFF or Portable Document Format (PDF) image data, the data includes a text file and a spreadsheet file which can be rasterized and converted into image data) of a shared file which can be transmitted in the facsimile transmission process is displayed on the display unit 1004. Then, the user selects the data to be transmitted by facsimile and the main control unit 1001 of the digital MFP 1020 fetches the data of the selected file.

At step S1005, a determination is made as to whether or not the start key 1205 has been pressed. When it is determined YES, at step S1006, a determination is made as to whether or not an original document of hardcopy is placed on a document placing table of the image scanning unit 1002. When it is determined YES, the process proceeds onto step S1007. When it is determined NO, the process proceeds onto step S1010. At step S1007, an image of the original document placed on the document placing table is scanned and converted into image data. The converted image data and image data of the selected data (when the data is not image data, the data is rasterized and converted into image data) are combined into combined image data to generate transmission image data. Further, according to necessity, a combining order of the pages in the combined image data is changed. A serial page number is inserted to the image data of each page. Then, at step S1008, a facsimile transmission process is executed. At step S1009, the line is released and the facsimile transmission process ends. Meanwhile, when it is determined NO at step S1006, at step S1010, a fact that there is no original document of hardcopy on the document placing table is displayed on the display unit 1004. Then, the facsimile transmission process ends. Further, in the process from NO at step S1006 to step S1010, for example, in case of using the scanned and converted image data as a cover letter, when hardcopy of the cover letter does not exist in the image scanning unit 1004, the combining process and the facsimile transmission process of the image data can be suspended. Accordingly, the data of the shared file on the network can be prevented from being attached and transmitted, and an attachment file can be attached properly.

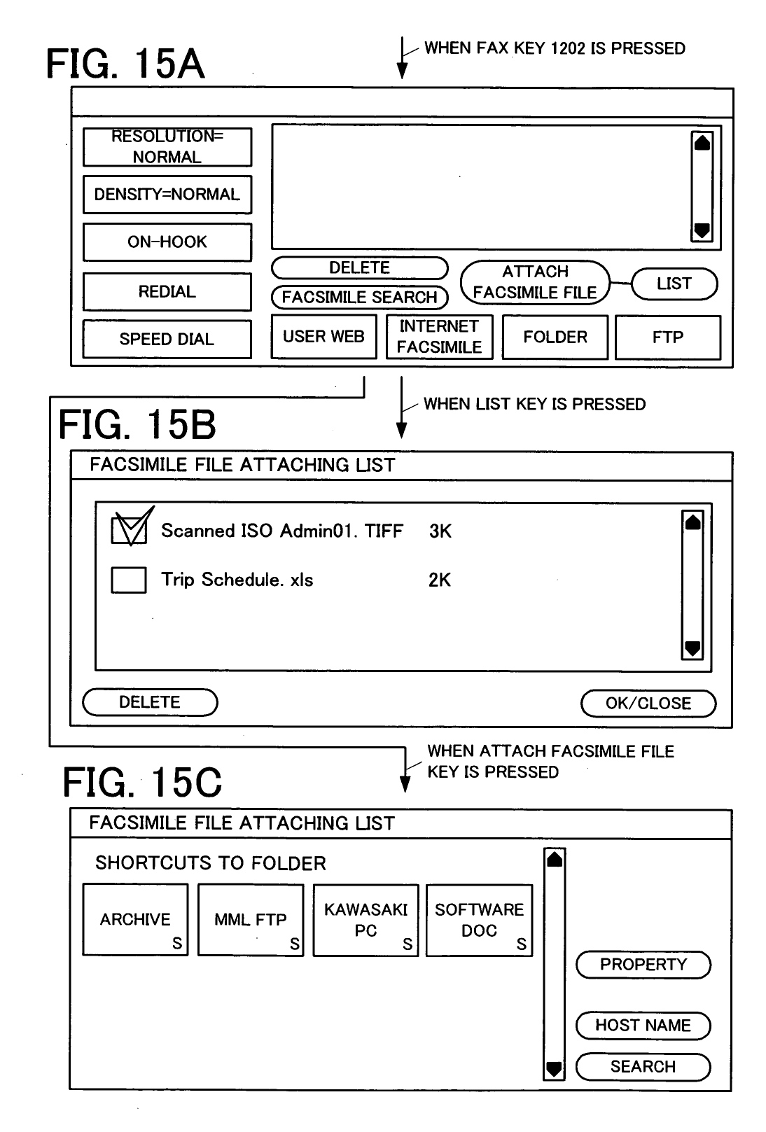

FIG. 15A through FIG. 19B are front views showing examples of each image displayed on the display unit 1004 when the facsimile transmission process of FIG. 14 is executed by the digital MFP 1020 of FIG. 10. In the following, with reference to FIG. 15A through FIG. 19B, the facsimile transmission process of FIG. 14 will be described.

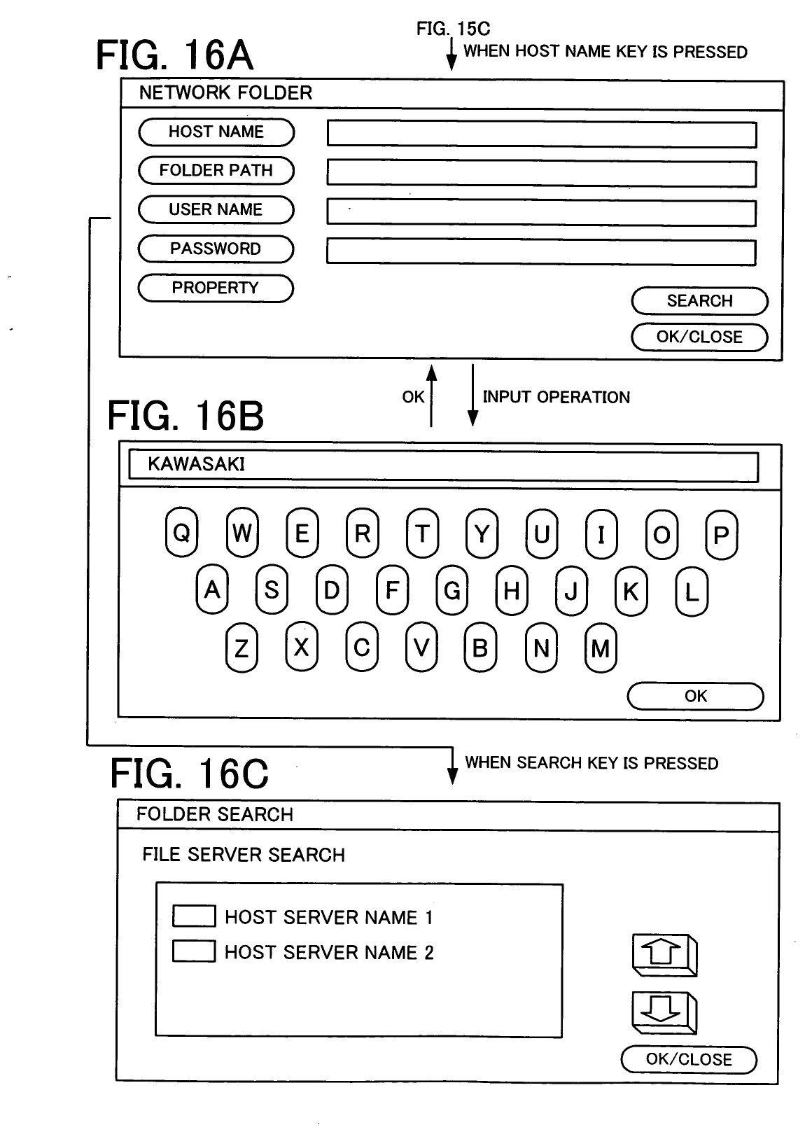

When the fax key 1202 is pressed on the operation unit 1005 of FIG. 13, a facsimile menu screen of FIG. 15A is displayed. When a list key at the right of the screen is pressed, a screen of a facsimile file attaching list of FIG. 15B is displayed. A list of files in the digital MFP 1020 which can be transmitted by facsimile is displayed. Meanwhile, when the attach facsimile file key is pressed on the screen of FIG. 15A, a screen of a facsimile file attaching list of FIG. 15C is displayed. On the screen of FIG. 15C, shortcuts to shared folders of devices on the LAN 1070 are displayed. When a host name key is pressed on the screen of FIG. 15C, a screen of FIG. 16A is displayed.

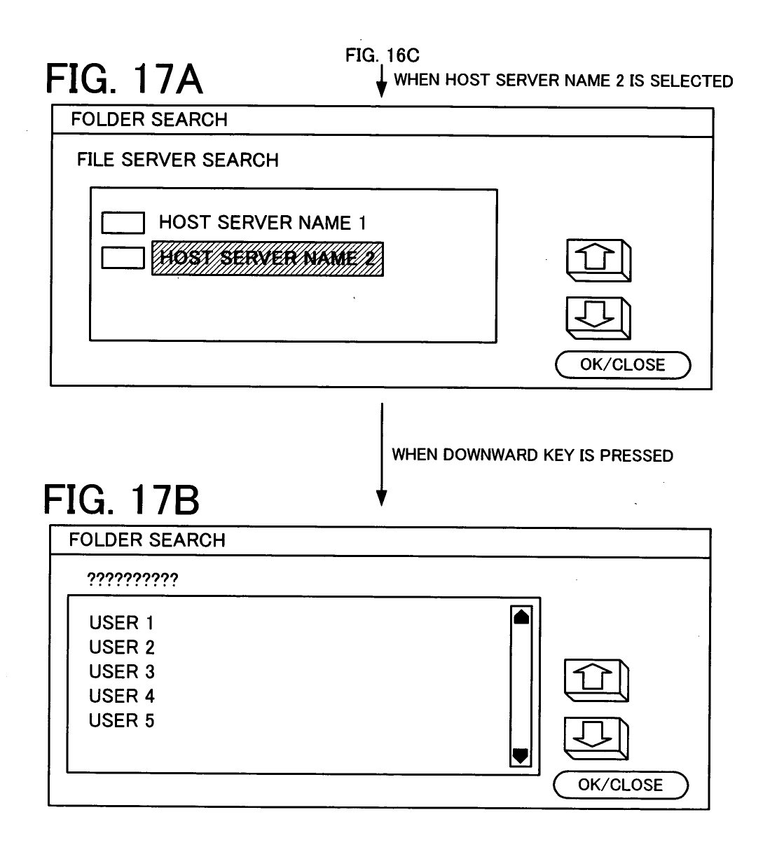

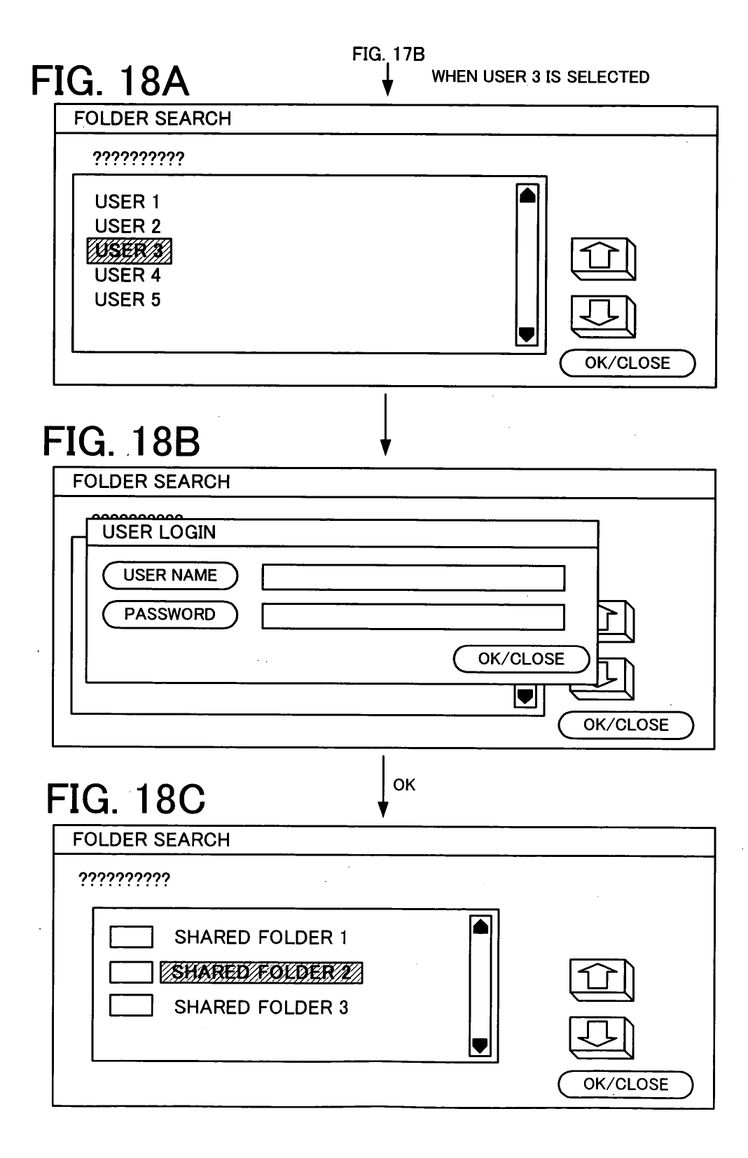

On a network folder screen of FIG. 16A, necessary data such as a host name, a folder path, a user name and a password can be input by carrying out an input operation from a keyboard screen of FIG. 16B. Then, when an OK button of FIG. 16B is pressed and each of the data of FIG. 16A has been input, by pressing a retrieval key of FIG. 16A, a folder search screen of FIG. 16C is displayed. Then, as shown in FIG. 17A, when a host server name 2 is touched and selected and a downward key is pressed on the screen of FIG. 17A, files in the folder are retrieved and a screen of FIG. 17B is displayed. When a user 3 is touched and selected on the screen of FIG. 17B as shown in a screen of FIG. 18A, a user login screen of FIG. 18B is displayed over the screen of FIG. 18A. When a user name and a password are input and an OK button is pressed, a folder search screen of FIG. 18C is displayed.

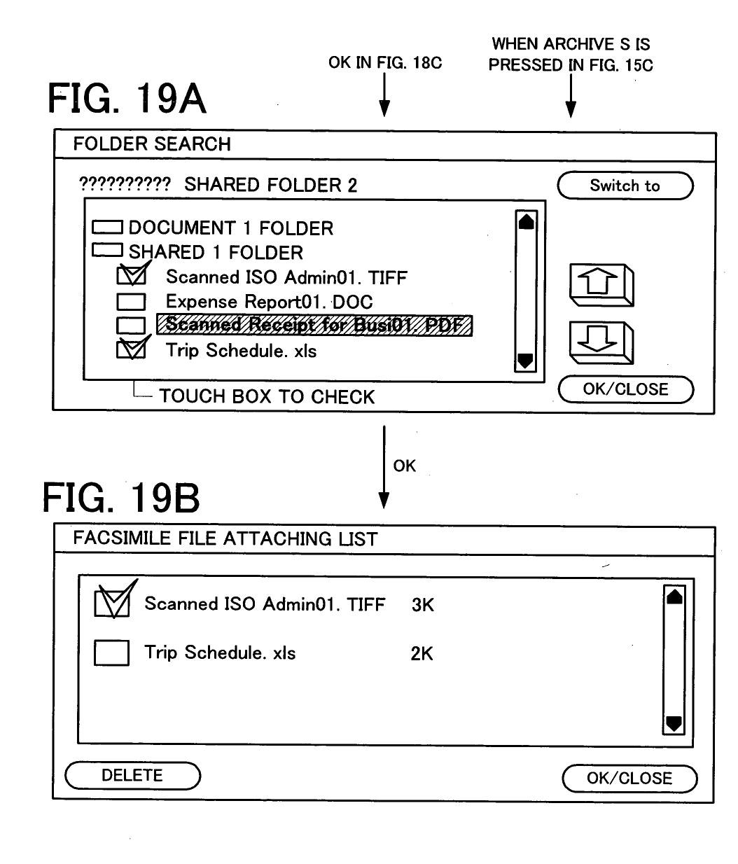

On the folder search screen on FIG. 18C, when a shared folder 2 is touched and selected and an OK button is pressed, a folder search screen of FIG. 19A is displayed. The screen of FIG. 19A displays data of files in the shared folder 2. When data to be transmitted by facsimile is touched and selected and an OK key is pressed, a screen of FIG. 19B is displayed. Accordingly, the data to be attached in the facsimile transmission process is designated. Further, when an archive S button is pressed on the screen of FIG. 15C, the screen of FIG. 19A is displayed.

As described above, according to the third embodiment of the present invention, among the data of the shared file stored in at least one of the client PC 1030 connected to the LAN 1070 and the digital MFP 1020, the digital MFP 1020 displays on the display unit 1004, only the image data which can be transmitted by facsimile in accordance with the extension of the data. The user selects the data of at least one shared file to be transmitted by facsimile (step S1004 of FIG. 14). Then, after fetching the selected data, the scanned image data and the image data of the selected data are combined into one combined image data and transmitted by facsimile (steps S1007 through S1008). Accordingly, the image data of the scanned original document and the image data of the data of the shared file in the terminal device connected to the network can be combined and transmitted by facsimile.

A detection is carried out for detecting whether or not there is an original document of an image to be scanned by the image scanning unit 1002 (step S1006). When there is no original document of the image, the process for combining the scanned image data and the image data of the selected data into one combined image data and transmitting the combined image data by facsimile is suspended (NO at step S1006 to step S1010). Accordingly, for example, in case of using the scanned and converted image data as the cover letter, when the hardcopy of the cover letter does not exist in the image scanning unit, the process for combining the image data and the facsimile transmission process can be suspended. As a result, the data of the shared file on the network can be prevented from being attached and transmitted and an attachment file can be attached properly.

### Other Embodiments

In the above-described third embodiment, an example of the digital MFP 1020 is described. However, the present invention is not limited to this example and can be applied widely to a facsimile machine and a facsimile server device or the like having a facsimile function.

1. A communication device comprising:
means for communicating with another communication device through a network;
means for inputting an identifier for specifying a file and a transmission destination of the file;
means for retrieving with the identifier input by the means for inputting as a retrieval key, a file having the identifier from files on the network; and
means for controlling to transmit the retrieved file to the transmission destination.

2. The communication device according to claim 1, wherein the identifier is included in the file and the means for controlling transmits the retrieved file after deleting the identifier from the retrieved file.

3. The communication device according to claim 1, wherein when a plurality of files are retrieved by the means for retrieving, the means for inputting selects a transmission file from the retrieved plurality of the files.

4. The communication device according to claim 1, wherein when a plurality of files are retrieved by the means for retrieving, the means for controlling transmits the plurality of the files.

5. A data conversion device comprising:
means for converting a file into a file format appropriate for transmission;
means for adding an identifier to the converted file; and
means for forwarding to another device or storing in the data conversion device, the file added with the identifier.

6. A communication device comprising:
means for communicating through a network;
means for inputting a retrieval condition and a transmission destination;
means for retrieving a file on the network in accordance with the retrieval condition;
means for displaying a retrieval result;
means for selecting a transmission file from the retrieval result;
means for determining whether or not to permit transmission of the selected file in accordance with a given transmission determining condition; and
means for controlling to transmit to the transmission destination, the file which the transmission is determined to be permitted by the means for determining.

7. The communication device according to claim 6, wherein the means for determining determines whether or not to permit the transmission of the file in accordance with the transmission determining condition provided for each communication protocol used in the transmission of the file.

8. The communication device according to claim 6, wherein the means for determining determines whether or not to permit the transmission of the file in accordance with the transmission determining condition provided for each transmission destination of the file.

9. The communication device according to claim 6, wherein the means for determining determines whether or not to permit the transmission of the file in accordance with the transmission determining condition provided for each transmitter of the file.

10. The communication device according to claim 6, wherein the means for determining determines whether or not to permit the transmission of the file in accordance with the transmission determining condition provided for each information relating to the selected file.

11. The communication device according to claim 6, wherein the information relating to the file includes at least one of a file type, a file size, a file owner and location information of the file.

12. The communication device according to claim 6, wherein the means for determining determines whether or not to permit the transmission of the file in accordance with one transmission determining condition or a plurality of transmission determining conditions.

13. The communication device according to claim 6, wherein the means for determining determines whether or not to permit the transmission of the file in accordance with a preset transmission determining condition among a plurality of transmission determining conditions.

14. The communication device according to claim 6, wherein the means for determining determines whether or not to permit the transmission only when a setting is made to carry out the determination in accordance with the transmission determining condition.

15. The communication device according to claim 6, wherein the means for retrieving retrieves the file on the network in accordance with the retrieval condition including at least one of information relating to the file such as a file name, a file size, a file type, character string information in the file, location information of the file and a file owner, a transmitter and a communication protocol.

16. The communication device according to claim 6, wherein when displaying the retrieval result, the means for displaying changes an item to be displayed in accordance with a setting.

17. The communication device according to claim 6, wherein the means for displaying displays a content of the file retrieved by the means for retrieving in accordance with an instruction.

18. A communication device connected to a network to which at least one terminal device is connected, the communication device comprising:
means for scanning an image of an original document and converting the scanned image into image data;
means for retrieving and selecting data of a shared file stored in at least one of the terminal device and the communication device and fetching the selected data; and
means for transmitting by facsimile, the scanned image data and image data of the selected data combined into one combined image data.

19. The communication device according to claim 18, further comprising means for converting which rasterizes the data of the shared file into image data of a prescribed format.

20. The communication device according to claim 18, wherein the combined image data includes a plural number of pages and the communication device further comprises means for changing and setting a combining order of the image data of each of the pages.

21. The communication device according to claim 18, wherein the combined image data includes a plural number of pages and the communication device further comprises means for inserting a serial page number to the image data of each of the pages.

22. The communication device according to claim 18, wherein among the data of the shared file, the means for retrieving displays and selects only image data which can be transmitted by facsimile.

23. The communication device according to claim 22, wherein in accordance with an extension of the data of the shared file, the means for retrieving displays and selects only the image data which can be transmitted by facsimile.

24. The communication device according to claim 18, wherein the means for transmitting detects a presence or an absence of an original document of an image to be scanned by the means for scanning, and in case of the absence of the original document of the image, the means for transmitting interrupts to transmit by facsimile, the scanned image data and the image data of the selected data combined into one combined image data.
